(19) United States
(12) Patent Application Publication
(10) Pub. No.: US 2014/0224717 A1
(43) Pub. Date: Aug. 14, 2014

(54) Wastewater treatment system with microbial fuel cell power

(71) Applicant: Graham John Gibson Juby, Fountain Valley, CA (US)

(72) Inventor: Graham John Gibson Juby, Fountain Valley, CA (US)

(21) Appl. No.: 13/815,236

(22) Filed: Feb. 12, 2013

(51) Int. Cl. C02F 3/10

(52) U.S. Cl. CPC C02F 3/102
USPC 210/151

(57) ABSTRACT

The membrane anaerobic stabilized wastewater treatment system may be substantially free of aerobic biological treatment for processing a wastewater influent. A primary membrane element may process a pretreatment stream produced by a pretreatment system and produce a product stream effluent. A secondary membrane element may receive and filter the product stream effluent to produce a concentrate stream effluent. The concentrate stream may be processed in a microbial fuel cell to convert the dissolved organic material to electronic power, carbon dioxide and an effluent liquid.

### BACKGROUND OF THE INVENTION

This invention relates to a system and method for treating domestic and industrial wastewater in a membrane anaerobic stabilization system that may use conventional primary treatment of influent that may then be microbiological processed in an anaerobic microbial fuel cell to efficiently produce electronic energy for power in operation of the wastewater treatment system as well as process product effluent for other beneficial uses.

Many water treatment agencies and industries have recognized the benefits of treating wastewater and recycling it for reuse. Such reuse might include, for example, reuse as irrigation water for crops, schools, parks, golf courses etc., or for industrial process water or cooling tower make-up water. The standards for recycled water quality vary slightly from state to state. The highest quality of water results from treatment that includes the use of microfiltration (MF) and reverse osmosis (RO) added on to conventional wastewater secondary treatment processes. In this case, the product water from RO can be further treated by an advanced oxidation process (AOP) and then used to recharge ground water basins, either by spreading or by direct injection into the ground.

Energy use has long been a focus for treatment plant owners and adding advanced treatment processes to existing treatment schemes adds to the energy demands. Biosolids disposal is another significant and on-going cost to wastewater treatment plant owners.

U.S. Pat. No. 7,318,894 (hereinafter the '894 patent) discloses an alternative treatment method for treating wastewater to produce RO quality product water that has a number of advantages to the MF and RO “add on” approach described above for producing groundwater recharge quality water. FIG. 1 herein illustrates a configuration of the '894 patent. The wastewater treatment system 10 may receive a wastewater influent 100 such as raw or screened sewage that may be from domestic sources, industrial sources or a blend of both that may be received by a primary treatment system of a pretreatment system 12. An anaerobic digestion system 80 may be used to further process the primary waste solids 82 communicated from pretreatment system 12. The primary membrane element 30 may be a microfiltration or ultrafiltration process that may receive primary effluent after further screening (not shown) for removal of any remaining bulk solids. The product stream 32 from the microfiltration step 30 may be processed further in a second membrane treatment step which may be a reverse osmosis or nano-filtration process 50. The solids in the waste stream from the microfiltration step 30 may be thickened and combined with the primary waste solids 82 and fed to anaerobic digestion 80. The high quality effluent from the reverse osmosis process 50 may be further treated by advanced oxidation processes (not shown) to result in a water suitable for groundwater recharge or other water reuse applications stream 52. The concentrate or retentate stream 54 from the secondary membrane process 50 may contain greater concentrations of dissolved organic material than the primary membrane element 30 effluent stream 32, and may be communicated with a high rate anaerobic digestion system 60 for conversion of the soluble organic material to energy in the form of methane gas 62. The digestion system fluid effluent stream 64 may be the final waste stream from the wastewater treatment system 10.

The system of the '894 patent presents a number of benefits compared with other known approaches for producing an RO quality product for groundwater or surface water augmentation or other reuse applications. Such benefits include: elimination of the conventional secondary biological treatment step which saves considerable energy and produces considerably less biosolids for disposal; a lower capital cost investment; a lower operating cost plant; potential to be more energy independent due to significantly more biogas production; a significantly smaller overall plant footprint; and approximately 50 percent less biosolids for disposal.

Although this system has many advantages, it relies on existing and developing technologies to convert the methane in the biogas produced by the high rate anaerobic digestion step to usable electrical energy. Such conversion is relatively inefficient today, for example internal combustion gas engines have an efficiency of about 35 percent and the remaining energy is lost or converted to heat, a portion of which can also be recovered. Micro turbines are another technology that can convert biogas to electrical energy and typically efficiencies are a little less than that of gas engines. A third example conversion technology is fuel cells, which may have a gas to electrical energy conversion efficiency of approximately 47 percent.

A method that improves on the conversion efficiency from methane to electrical power would improve the overall energy efficiency of the process and make the overall system more sustainable in terms of being able to provide more of its own electrical energy power needs. A method that converts organic material directly to electrical energy may be a more efficient approach. Microbial fuel cells or biological fuel cells that may be basically a bio-electrochemical system that drives a current by structuring interactions found in nature have been investigated in recent years. Various systems for electron transfer from microbial cells to an electrode have been studied and may include electron transfer aided by a mediator additive or mediator-free microbial fuel cells. The fuel cells for microbial activity require anaerobic conditions to produce efficient electron activity. The disclosed invention combination of an efficient anaerobic wastewater treatment process and an anaerobic energy producing process that uses the products of the treatment process addresses the need for improved energy efficiency in wastewater treatment and provides further related advantages.

### SUMMARY OF THE INVENTION

The present invention resides in a system and method for treating wastewater more efficiently. It uses elements of the configuration disclosed in U.S. Pat. No. 7,318,894 that is herein incorporated by reference, but replaces the high rate anaerobic treatment with a microbial fuel cell. The configuration is illustrated in FIG. 2 of the application. The concentrate stream or retentate from the second membrane element that may be reverse osmosis or nano-filtration or other membrane separation process feeds the microbial fuel cell. The microbial fuel cell may contain a group of specialized bacteria that convert the soluble organic material into carbon dioxide gas, water and electrical energy.

The effluent stream from the microbial fuel cell may be the final waste stream from the wastewater treatment system, but may also be used as a source of nutrients, such as nitrogen and phosphorous, which may be recovered for reuse by existing and developing technologies. Such nutrient recovery processes may be situated either upstream or downstream of the microbial fuel cell system.

A major advantage of this structural combination over existing processes and systems is that in this configuration the soluble organic material in the concentrate stream is converted directly to electrical energy without the intermediate step of methane gas production. This increases the overall conversion efficiency of the organic matter to electrical energy by 20 percent or more. A second advantage of this approach is that the downstream conversion process for biogas to electrical energy that may be either gas engine, gas turbine, fuel cell or the like is eliminated, saving both capital and operating and maintenance costs.

These and other features, aspects and advantages of the present invention will become better understood with reference to the following drawings, description and claims.

### BRIEF DESCRIPTION OF THE DRAWINGS

FIG. 1 illustrates a functional diagram of a prior art wastewater treatment system;

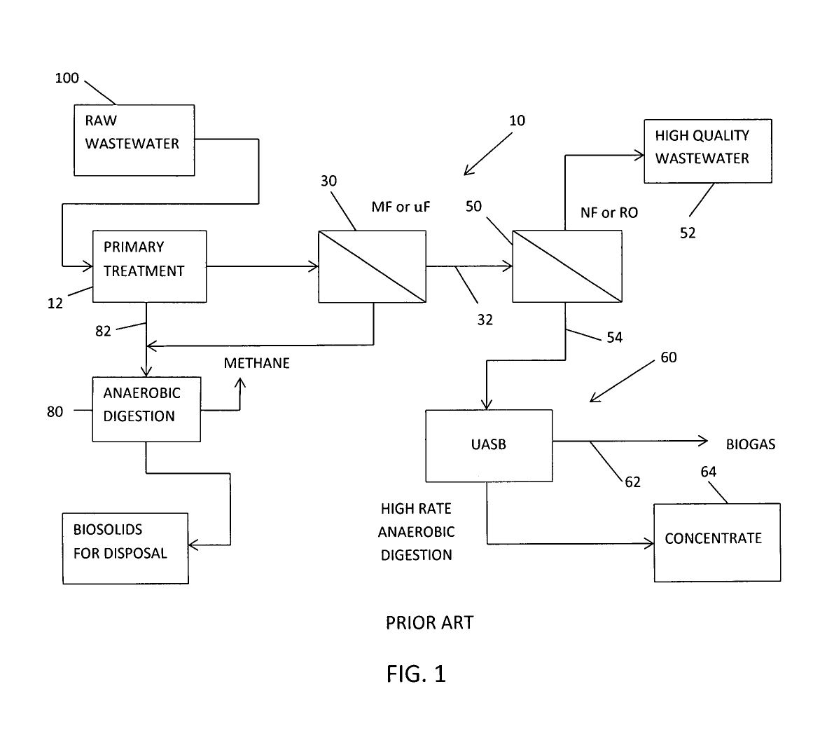

FIG. 2 illustrates a functional diagram of a microbial fuel cell in combination with an example anaerobic stabilization system according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

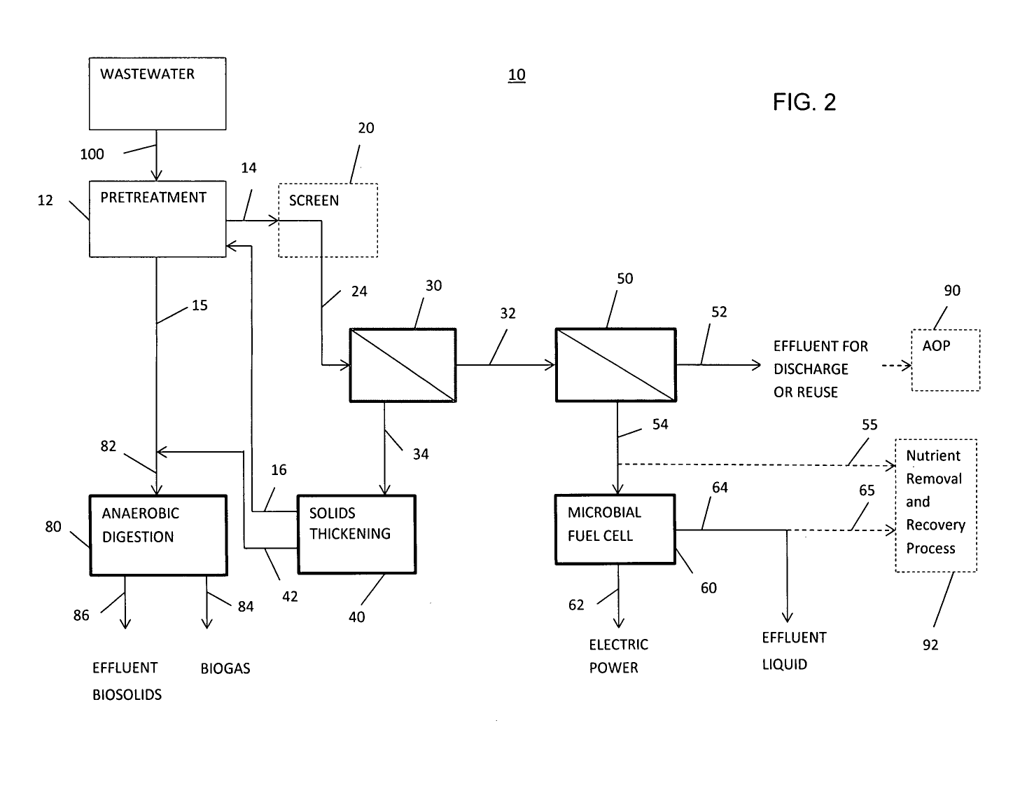

Referring to FIG. 2, a functional diagram of a wastewater treatment system 10 that is a membrane anaerobic stabilization system with microbial fuel cell 60 augmentation is illustrated. For purposes of disclosure of the microbial fuel cell 60 utility in combination with a basically anaerobic process, the system 10 may have a conventional pretreatment system 12 for a wastewater influent 100. The pretreatment effluent 14 may be filtered in a primary membrane element 30, or may be first filtered in a screen element 20 for removal of any remaining bulk solids to produce a screened effluent 24 for membrane filtration in primary membrane element 30. The pretreatment system 12 may also produce a primary waste solids 15 that may be combined with thickened solids stream 42 produced from a waste solids stream 34 that may be produced by the primary membrane element 30 to form a blended solids stream 82 to be processed in an anaerobic digestion system 80 to produce a methane gas 84 and effluent biosolids 86.

The primary membrane element 30 may be a microfiltration or ultrafiltration process that produces a product stream 32 for further processing in a second membrane element 50 that may be a reverse osmosis or nanofiltration process. The solids in the waste stream 34 from the primary membrane element 30 may be thickened and processed as described above. The solids depleted recycled stream 16 may be recycled to the pretreatment system 12. Biogas 84 containing methane produced by the anaerobic digestion system 80 may be converted to electrical energy using known technologies. The effluent liquid 52 of the secondary membrane element 50 that may be a high quality effluent may be further treated by an advanced oxidation process 90 to further refine water for groundwater recharge or other water reuse applications.

The concentrate or retentate stream 54 from the secondary membrane element 50 may contain greater concentrations of dissolved organic material than the primary membrane element 30 effluent product stream 32. The concentrate stream 54 is particularly suitable for processing as fuel in a microbial fuel cell 60. For electric power production in a microbial fuel cell the micro-organisms are processed in an anaerobic environment to produce carbon dioxide, protons and electrons. This is particularly compatible with the process and system of the wastewater treatment system 10 as described above for a membrane anaerobic stabilization system. Both the system 10 and the microbial fuel cell 60 operate in an anaerobic environment in a synergist manner.

In the system 10 the concentrate stream 54 is communicated to the microbial fuel cell 60 for conversion of the soluble organic material to carbon dioxide and electric power 62 with a concentrate effluent liquid 64. The microbial fuel cell 60 effluent stream 64 may be the final waste stream from the wastewater treatment system 10. This effluent stream 64 may contain higher concentrations of nitrogen and phosphorous than the primary membrane element 30 product stream 32 and may be utilized as a feed stream for recovery of nutrients. The nutrient recovery process 92 may be applied either upstream or downstream of the microbial fuel cell 60 process in streams 54 or 64, reference streams 55 and 65.

While the invention has been particularly shown and described with respect to the illustrated embodiments thereof, it will be understood by those skilled in the art that the foregoing and other changes in form and details may be made therein without departing from the spirit and scope of the invention.

I claim:

1. A system for treating a wastewater stream comprising:
a pretreatment system substantially free of aerobic biological treatment in communication with a wastewater influent;
a primary membrane element in communication with said pretreatment system to receive a pretreatment effluent to produce a product stream effluent;
a secondary membrane element in communication with said primary membrane element to receive and filter said product stream effluent and to produce a concentrate stream; and
a microbial fuel cell in communication with said secondary membrane element to receive said concentrate stream to convert the dissolved organic material of said concentrate stream to electronic power, carbon dioxide, and an effluent liquid.

2. The system as in claim 1 wherein a screen element is disposed intermediate said pretreatment system and said primary membrane element to remove bulk solids from said pretreatment effluent.

3. The system as in claim 1 wherein said primary membrane element is selected from the group consisting of a microfiltration system and an ultrafiltration system; and
said secondary membrane element is selected from the group consisting of a reverse osmosis system and a nanofiltration system.

4. The system as in claim 1 wherein said concentrate stream is processed in a nutrient removal and recovery process as a source for recovery of the nutrients nitrogen and phosphorous.

5. The system as in claim 1 wherein said effluent liquid is processed in a nutrient removal and recovery process as a source for recovery of the nutrients nitrogen and phosphorous.
